(19) United States
(12) Patent Application Publication
(10) Pub. No.: US 2015/0106158 A1
(43) Pub. Date: Apr. 16, 2015

(54) METHOD AND APPARATUS FOR PROVIDING FOLKSONOMIC OBJECT SCORING

(71) Applicant: Verizon Patent and Licensing Inc., Basking Ridge, NJ (US)

(72) Inventor: Madhusudan RAMAN, Sherborn, MA (US)

(73) Assignee: Verizon Patent and Licensing Inc., Basking Ridge, NJ (US)

(21) Appl. No.: 14/055,207

(22) Filed: Oct. 16, 2013

(51) Int. Cl. G06Q 30/02; G06F 17/30; G06Q 50/00

(52) U.S. Cl. CPC G06Q 30/0201; G06Q 50/01; G06F 17/30861
USPC 705/7.29

(57) ABSTRACT

An approach for providing folksonomic object scoring includes processing user content according to a folksonomic vocabulary to determine one or more mentions of a concept object in the user content. An initiation of the processing, an ending of the processing, an extent of the user content, or a combination thereof is based on a cost function. The approach also includes calculating an impact score for the concept object based on the one or more mentions.

### BACKGROUND INFORMATION

Managing how consumers view or feel about certain concepts (e.g., brands, products, people, etc.) has become more complicated as the expansion of marketing, sales, and service channels creates a vast array of user data or content that can be analyzed to determine such views or feelings. As a result, service providers face significant technical challenges to enable processing of user data or content to quantify real-time and future impacts regarding how consumers feel about certain concepts such as brands, products, etc.

Based on the foregoing, there is a need for an approach for folksonomic scoring of concepts (e.g., encapsulated as concept objects) to facilitate managing how those concepts are perceived by consumers and other users.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing folksonomic object scoring, according to one embodiment;

FIG. 2 is a diagram of a system utilizing a folksonomic object scoring platform over a cloud network, according to one embodiment;

FIG. 3 is a diagram of user content streams available for processing by the folksonomic object scoring platform, according to one embodiment;

FIG. 4 is a diagram illustrating a summarize example of user content that can be analyzed for impact scoring, according to one embodiment;

FIG. 5 is a diagram of a folksonomic object scoring platform, according to one embodiment;

FIG. 6 is a flowchart of a process for calculating an impact score via a folksonomic object scoring platform, according to one embodiment;

FIG. 7 is a flowchart of a process for predicting impact scores and triggering actionable alerts based on the predicted impact scores, according to one embodiment;

FIG. 8 is a flowchart of a process for segmenting users via a folksonomic object scoring platform, according to one embodiment;

FIGS. 9A and 9B are diagrams of respectively static segments and dynamic segments, according to various embodiments;

FIG. 10 is a flowchart of a process for creating a folksonomic map and/or score visualization, according to one embodiment;

FIGS. 11A and 11B are diagrams of respectively of a folksonomic map based on dynamic segments and a folksonomic map based on static segments, according to various embodiments;

FIG. 12 is a diagram of an impact score graph, according to one embodiment;

FIG. 13 is a diagram of a computer system that can be used to implement various exemplary embodiments; and

FIG. 14 is a diagram of a chip set that can be used to implement various exemplary embodiments.

### DESCRIPTION OF THE PREFERRED EMBODIMENT

A method, apparatus, and system for providing folksonomic object scoring are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although various embodiments are described with respect to folksonomic object scoring for brands as one example of a concept, it is contemplated that the embodiments described herein are applicable to any concept or concept object for which user content and/or behavior can be associated with. In addition to brands, other example concepts may include, for instance, products, people, items, sentiments, etc. to which users may be exposed. In one embodiment, a concept object refers to a data representation of a concept that is to be scored.

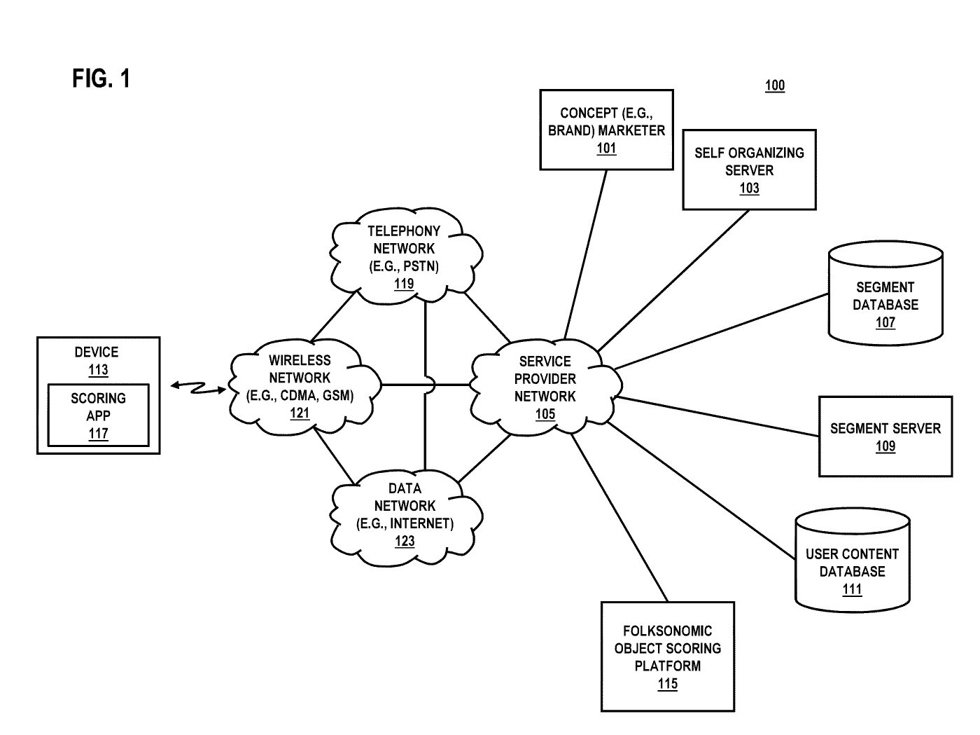

FIG. 1 is a diagram of a system capable of providing folksonomic object scoring, according to one embodiment. Traditionally, intelligence about how a concept is perceived by consumers (e.g., brand intelligence) has been measured at the pace at which a marketer or other surveyor can absorb or measure the insight, typically quarterly or annually. However, in the modern digital world, the traditional sampling frequency can be too infrequent. In many cases, the sampling frequency is limited by methodology and available resources. For example, brand or concept perceptions are historically measured using representative samples of consumers, e.g., ranging from 500 to 5,000 participants, using traditional surveying methods that often take a substantial period of time to complete.

As noted above, real-world consumers may express themselves in a variety of digital media communities (e.g., social media, blog posts, web pages, etc.) leaving a vibrant digital wake of real-time opinions that can potentially have a significant impact on consumer views and feelings about particular concepts (e.g., brands). The extent and volume of user content created by such digital media communities are both expanding rapidly and being produced at much faster rates. For example, it is noted that more than 80% of U.S. online adults create 188 billion influence impressions of products and services that can be mined for brand or concept intelligence. However, traditional perception systems either can be overwhelmed by or ignore such a volume of user content, thereby limiting a marketers or surveyors ability to mine such data.

To address these problems, a system 100 of FIG. 1 introduces the capability to continuously calculate and/or predict impact scores with respect to a concept or concept object (e.g., a brand) by analyzing user content for mentions or impressions of the concept in the user content. More specifically, the system 100 provides for the following capabilities with respect to generating impact scores for concepts or brands: (1) comprehensive tapping into user content from multiple spaces include web, mobile application space, third party spaces, etc. driven by a real-time cost function; (2) tapping into mobile application space for collecting user content data without requiring changes to mobile applications; (3) automated mapping of traditional consumer segments (e.g., demographics-based segments) to dynamically discover classifications or segments of digital-consumers; (4) tracking of the rate of change and associated threshold measures for triggering actionable alerts based on impact scoring; (5) quantitative impact scoring that is differentiated from traditional word cloud taxonomies of mentions; and (6) use of predictive scoring models that leverage both inductive and deductive reasoning.

For example, in a use case in which the concept to score against is a brand, the system 100 helps manage brand impact on digital consumers by introducing continuously scored predictions of brand associated digital-market measures. In one embodiment, analysis for the mentions or impressions to determine impact scores is based on folksonomy. By way of example, folksonomy broadly refers to a process for classifying user content (e.g., digital media, postings, documents, etc.) based on collaborative creation and management of content tags. Folksonomy includes, for instance, classifying user content (e.g., consumer posts or topics) using their own tags and terms until a usable structure (e.g., a folksonomic vocabulary) emerges.

In one embodiment, there are at least two types of folksonomy: a broad folksonomy and a narrow folksonomy. A broad folksonomy, for instance, is one in which multiple users tag particular content with a variety of terms from a variety of vocabularies, thus creating a greater amount of metadata for that content. A narrow folksonomy, on the other hand, occurs when a few users, primarily the content creator, tag an object with a limited number of terms. In either case, folksonomy relies, in part, on the idea that analysis of the complex dynamics of tagging systems has shown that consensus around stable distributions and shared vocabularies emerge, even in the absence of a central controlled vocabulary. In one embodiment, the system 100 leverages this folksonomic vocabulary to process user content for impact scoring.

In other words, the system 100 recognizes that digital channel interaction wakes (e.g., user content data created or recorded in response to user perceptions of a concept or brand) are an effective proxy for assessing consumer experience with particular concepts or brands. In this way, the system 100 enables adoption of a fact drive approach to determining experimental outcomes to consumer exposure to different concepts or brands (e.g., including exposure to marketing campaigns associated with the concept or brand). These approaches enable the system 100 to support the intersection of semantic and timely contextualization of user content (e.g., social as well as other online user data and content including operational and/or transactional data).

In one embodiment, the system 100 provides folksonomic object scoring services that support hybrid consumer segmentation (e.g., combining static and dynamic segments), cost function driven data wake spidering, and a bridging of traditional web segments with mobile application space enabled segments. For example, with respect to hybrid consumer segmentation, the system 100 facilitates a brand or concept owner, marketing agency, or other interested party to granularize the creation of consumer segments based on a mapping of traditional static segments to real-time dynamically discovered segments. In another embodiment, the system 100 further introduces relative scoring that enables tracking of how well a concept or brand manages the perception of meeting it's consumers' future needs, wants, and behaviors as well as quantitative extrapolation of estimated recency, frequency, and monetization potential.

For example in a hybrid segmentation approach, a typical static segment would be a demographic group such as those based on age segmentation (e.g., under 21, age 22-35, etc.), income segmentation (e.g., income less than $10,000, income from $10,001 to $40,000, etc.), geographic segmentation (e.g., residence in a particular state, county, zip code, etc.), and the like. In contrast, an example of dynamic segment as determined by the system 100 attuned to social, local, and mobile (SOLOMO) segments could be a segment with “high propensity to buy an item between $1.50 and $3.75.” A difference between a static segment and a dynamic segment is that contextual otherness (e.g., youth or urban versus rural or single versus married) are not the focus of the segment in the dynamic approach. For dynamic segments, the focus is instead an aspirational objective (e.g., sell an item in a price range possibly at a location) that is contextually immediate.

In one embodiment, as shown in FIG. 1, a concept or brand marketer 101 accesses a self organizing server 103 over a service provider network 105 to obtain a master consumer segment list from a segment database 107. In one embodiment, the concept marketer 101 may be subject to authentication prior to accessing the self organizing server 103. From the master segment list, the concept marketer 101, for instance, a subset vector definition to initiate a dynamic consumer segmentation process. For example, the vector definition includes traditional static segments (e.g., demographics based segments) as well as data wake asset preference (e.g., specifying which user content streams to process), and cost function for the costliest asset and/or overall concept impact spidering budget (e.g., in terms of memory resources, bandwidth resources, monetary costs, etc.). Other factors that may be include in the vector definition include incentive management budget for hypothesis testing, sentiment or folksonomic vocabulary, public internet stream designations, mobile application space designations, and/or third party stream designations.

In one embodiment, the vector definition establishes a starting state of seed static segments for the concept or brand which are instantiated in a segment server 109 that registers via, for instance, a high velocity web-based interface for the data stream inputs from the user content database 111. By way of example, the data streams may be obtained from user content sources (e.g., public internet, mobile application space at a user device 113, third parties, etc.) by spidering, direct application programming interfaces (APIs), or other interface to user content data.

In one embodiment, a folksonomic object scoring platform 115 uses the vector definitions to score the user content database 111 (e.g., comprising various user content streams from the public internet, mobile application space, third party streams, etc.) continuously, a regular intervals, according to a schedule, and/or on demand for relevancy to a target concept or brand. For example, relevancy can be determined by lexical and/or semantic analysis of mentions related to the concept of brand in the user content. In one embodiment, the folksonomic object scoring platform 115 can also update the vector definitions iteratively based on the results of the scoring and/or reclassification of consumer segments.

In one embodiment, the folksonomic object scoring platform 115 can predict future impact scores for a concept or brand based on, for instance, tracking or monitoring of rate of change of impact scores determined over a period of time. The predictive scoring, for instance, leverages both inductive and deductive reasoning based on various predictive models. In one embodiment, the models are ensemble models comprising multiple models of multiple types (e.g., experiential models such as neural networks, regression models, etc.). In one embodiment, the models adhere to the Predictive Modeling Markup Language (PMML) standard. By way of example, the ensemble models of the system 100 support a combination of data-driven insight and expert knowledge into a single and powerful decision strategy. Neural network models, for instance, encapsulate “experiential” rules used by experts to provide impact scoring for concepts or brands (e.g., expert knowledge). Then predictive analytics augments the experiential rules based on an ability to automatically recognize patterns in data not obvious to the expert eye. As a result, the ensemble model approach described herein uses more than one model to arrive at a consensus classification or impact scoring for a given set of user content data.

In one embodiment, folksonomic object scoring platform 115 determines the extent of the digital data wake (e.g., user content data) to process according to a preset cost function threshold. In some embodiments, the folksonomic object scoring platform 115 may offer incentives to consumers for participating or otherwise allowing their user content data or digital data wakes to be processed according to the various embodiments described herein.

In one embodiment, the device may execute a scoring application 117 to perform all or a portion of the functions of the folksonomic object scoring platform 115. In this way, user content data associated with the mobile application space of the device 113 need not be transmitted from the device 113 to further enhance privacy and security of user content data.

For illustrative purposes, the folksonomic object scoring platform 115, the device 113, and/or the scoring application 117 have connectivity to the service provider network 105 via one or more of networks 119-123. In one embodiment, networks 105 and 119-123 may be any suitable wireline and/or wireless network, and be managed by one or more service providers. For example, telephony network 119 may include a circuit-switched network, such as the public switched telephone network (PSTN), an integrated services digital network (ISDN), a private branch exchange (PBX), or other like network. Wireless network 121 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 123 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 105 and 119-123 may be completely or partially contained within one another, or may embody one or more of the aforementioned infrastructures. For instance, the service provider network 105 may embody circuit-switched and/or packet-switched networks that include facilities to provide for transport of circuit-switched and/or packet-based communications. It is further contemplated that networks 105 and 119-123 may include components and facilities to provide for signaling and/or bearer communications between the various components or facilities of system 100. In this manner, networks 105 and 119-123 may embody or include portions of a signaling system 7 (SS7) network, or other suitable infrastructure to support control and signaling functions.

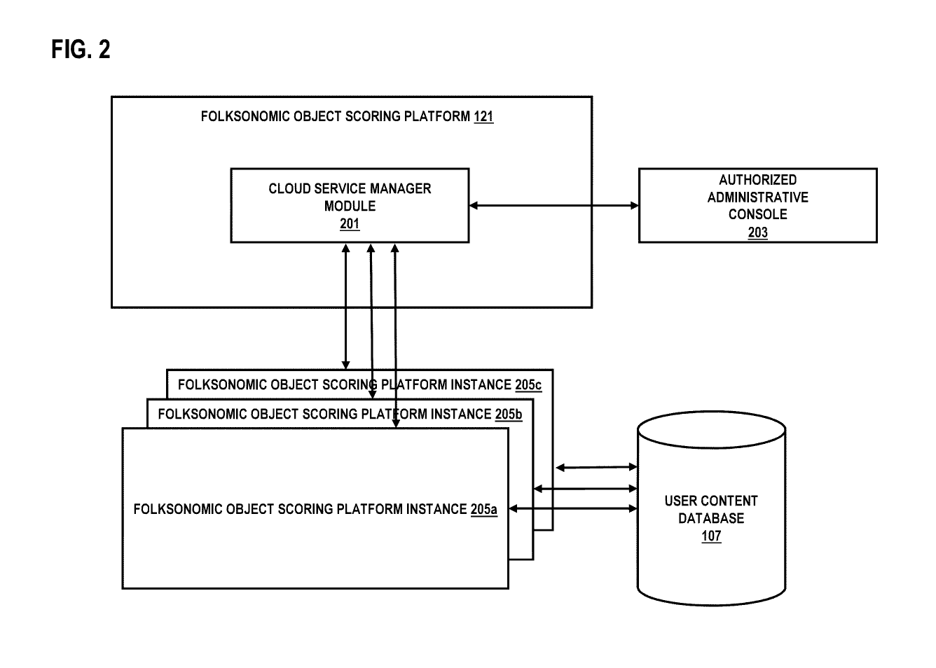

FIG. 2 is a diagram of a system utilizing a folksonomic object scoring platform over a cloud network, according to one embodiment. In one embodiment, the folksonomic object scoring platform 115 can be instantiated as a cloud service. In a cloud-based embodiment, the folksonomic object scoring platform 115 is controlled by a cloud service manager module 201. The authorized administrative console 203 is used to access the cloud service manager module 201 to use the cloud service manager module 201 to create instances 205a-205c (also collectively referred to as instances 205) of the folksonomic object scoring platform 115 for a channel partner.

The cloud service manager module 201 generates an instance 205 of the folksonomic object scoring platform 115 on demand associated with a channel partner. Each instance 205 of the folksonomic object scoring platform 115 gives the channel partner requesting access through the cloud network (e.g., cloud service 105) the ability to manage the services provided. These services include concept or brand impact scoring, consumer segmentation, impact score prediction, triggering of actionable alerts based on impact scoring, etc.

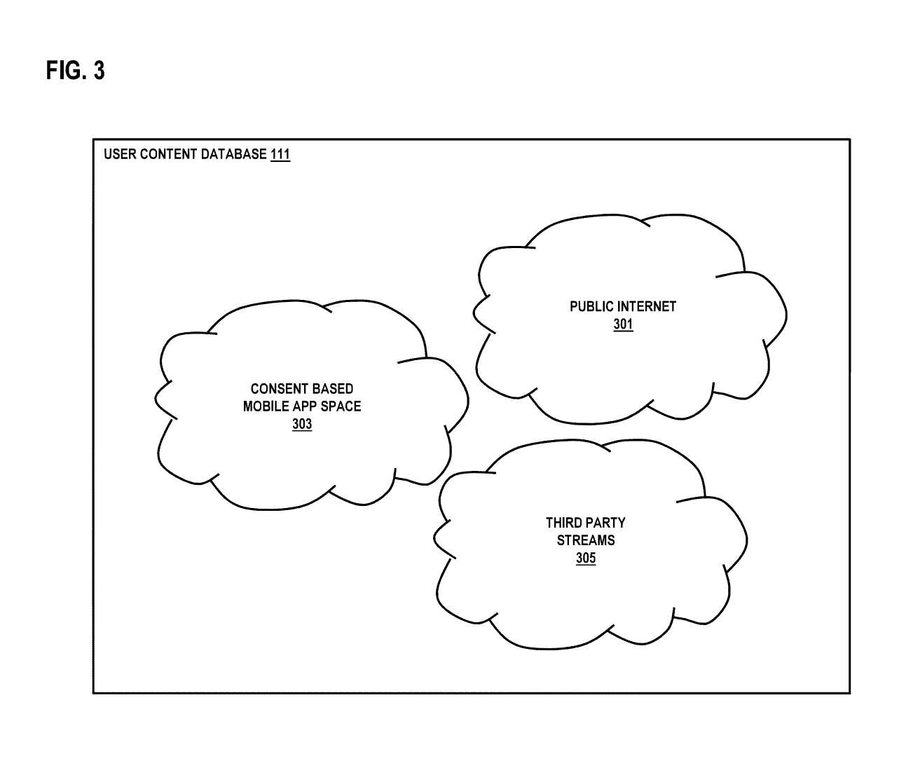

FIG. 3 is a diagram of user content streams available for processing by the folksonomic object scoring platform, according to one embodiment. In one embodiment, the user content database 111 provides streams of user content data for scoring by the folksonomic object scoring platform 115. By way of example, the user content may include textual data, image data, audio data, video data, and/or any other data digital data type.

As noted previously, the user content database 111 may consist of any number of user content data sources or streams. In one embodiment, as shown in FIG. 3, the use content database 111 includes user data streams available from the public internet 301, mobile application space 303, and third party streams 305. By way of example, content data from the public internet 301 includes user content data that posted to public web sites or data repositories available over the Internet.

In one embodiment, user content data from the mobile application space 303 includes user content data generated by applications executing on, for instance, the device 113. By way of example, the data streams from the mobile application space 303 may be obtained through APIs or other monitoring of the contents of the device 113. In one embodiment, access to such user data is based on user consent.

In embodiment, user content or other data available from third parties 305 for scoring and/or user segmentation include databases available from enterprises, governments, vendors, or other external data repositories. In some cases, access to data from the third parties 305 may be by subscription (e.g., free and paid), agreement, or the like. Such access may also require authentication or other form of verification.

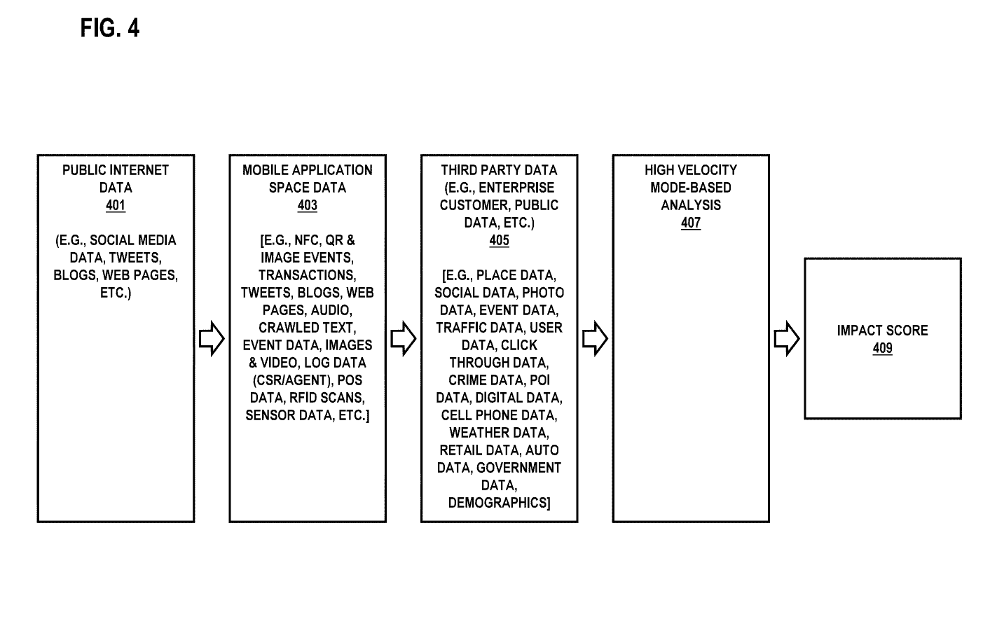

Examples of user content data from each of three spaces are further discussed below with respect to FIG. 4.

FIG. 4 is a diagram illustrating a summarize example of user content that can be analyzed for impact scoring, according to one embodiment. Technologically, user content (e.g., text, audio, images, videos, etc.) attributable to digital-consumer activity can provide a cohesive snapshot of the prevailing state of consumer opinion albeit in a terms of a big and unstructured real-time flow of information. The folksonomic object scoring platform 115 taps into this flow to provide “here and now insight” that ties live consumer opinion to predict user perception with respect to a concept or brand. For example, user perception may reveal or predict purchase intent, brand specific metrics, as well as pricing, promotion, and/or marketing campaign effectiveness.

As shown in FIG. 4, an example user content flow includes user content from public internet data 401, mobile application space data 403, and third party data 405. Examples of user content from public internet data 401 include social media data, tweets, blogs, web pages, and the like. Examples of mobile application space data 403 include user content collected directly from a user device 113 and/or the applications executing on the device 113.

Mobile application space data 403 include, for instance, application activity, application generated content, etc. such as near field communication (NFC) events, quick response (QR) code reading, image events, transactions, tweets sent from native applications, blogs generated from native applications, web pages accessed via native applications, audio, images, videos, crawled text, event data, log data (e.g., generated from interactions with customer service representatives or agents), point of sale (POS) data, radio frequency identification (RFID) scans, sensor data, and the like. In one embodiment, the system 100 accesses mobile application space data 403 without requiring changes to the applications executing at the device 113. Instead, the system 100 can access application space data 403 through techniques typically reserved for the other two data categories 401 and 405.

In one embodiment, third party data 405 includes enterprise customer data, public data, vendor data, and the like. Examples of third party data 405 include place data, social data, photo data, event data, traffic data, user data, click through data, crime data, point-of-interest (POI) data, digital data, cell phone data, weather data, retail data, vehicle (e.g., auto) data, government data, demographics, and the like.

In one embodiment, the data flow comprising the public internet data 401, the mobile application data 403, and/or the third party data 405 are scored via high velocity mode-based analysis 407 to generate an impact score 409 for a concept of brand. By way of example, the high velocity mode-based analysis 407 includes correlation, clustering, pattern analysis, segmentation, semantic analysis, sentiment analysis, social analysis, trend analysis, ontological analysis, and the like. In one embodiment, the folksonomic object scoring platform 115 is implemented as a machine-to-physical (M2P) platform that leverages scoring and predictive services based on various models (e.g., ensemble predictive models as described above). In one embodiment, the predictive models can be customized for a particular customer or enterprise.

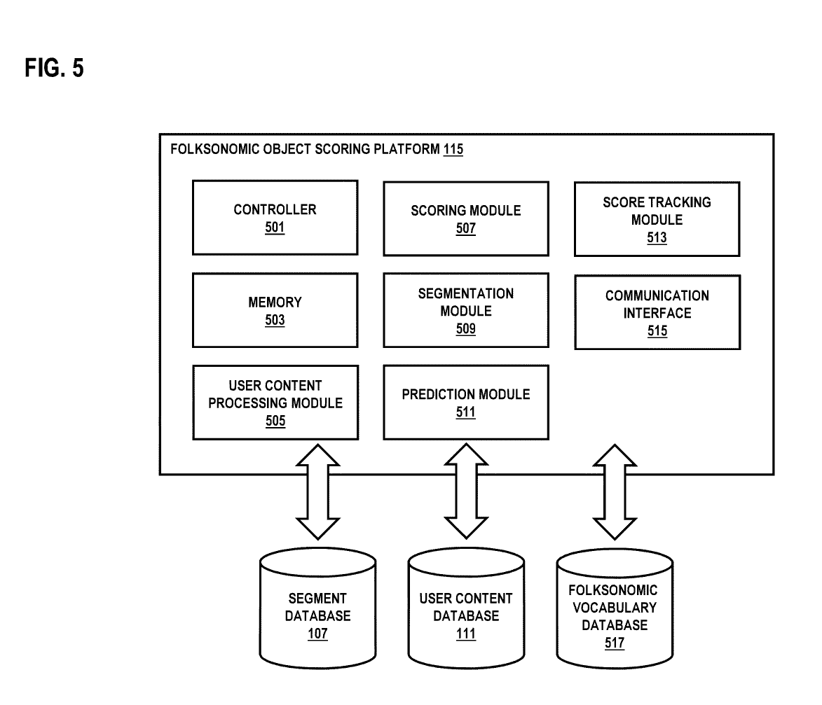

FIG. 5 is a diagram of a folksonomic object scoring platform, according to one embodiment. By way of example, the folksonomic object scoring platform 115 includes one or more components for scoring and/or predicting impact scores for a concept or brand based on analysis and segmentation of user content. It is contemplated that the functions of these components may be combined in one or more components or performed by other components of equivalent functionality. In this embodiment, the folksonomic object scoring platform 115 includes a controller 501, a memory 503, a user content processing module 505, a segmentation module 507, a scoring module 509, a prediction module 511, a score tracking module 513, a communication interface 515, and a folksonomic vocabulary database 517. In one embodiment, the folksonomic object scoring platform 115 also has access to the segment database 107 and the user content database 111.

The controller 501 may execute at least one algorithm (e.g., stored at the memory 503) for executing functions of the folksonomic object scoring platform 115. For example, the controller 501 may interact with the user content processing module 505 to process user content (e.g., from the user content database 111) to determine whether the user content contains mentions related to a target concept (e.g., a brand). For example, user content may represent digital channel interaction wakes created by a given digital-consumer or user. In one embodiment, a digital-consumer represents any digital identity embedded in the data sources that comprises the user content database 111 (e.g., social media, web, survey, operational, and transactional data). As noted above, user content data can span any number of data spaces including the public internet, private device application space, and third party data sources along with enterprise transactional and operational support data.

In one embodiment, the user content processing module 505 uses lexical analysis, semantic analysis, sentiment analysis, etc. (e.g., as described above with respect to the analysis 407 of FIG. 4) to perform automated and machine learned parsing of user content to determine mentions of a concept. In one embodiment, the user content processing module 505 may determine the user content and the extent of the user content digital wake to process based on specified preferences and/or a cost function. The cost function, for instance, may specify thresholds for resources (e.g., memory, computational resources, monetary resources, bandwidth resources, etc.) that are to be used for content processing. Based on the thresholds and/or resource availability, the user content processing module 505 can determine when to start or stop user content processing including how much of the content to process. It is contemplated that the user content processing module 505 may use any textual recognition, image recognition, object recognition, audio recognition, speech recognition, etc. techniques for identifying potential text, images, audio, and the like from user content. The user content processing module 505 then analyzes the potential mentions against the folksonomic vocabulary database 517 to determine whether the potential mentions relate to a concept or brand.

The user content processing module 505 then interacts with the scoring module 507 to calculate an impact score based on the extracted mentions of a concept of brand. In one embodiment, the scoring module 507 uses one or more of the analyses described with respect to the analysis 407 of FIG. 4 to determine whether the mentions are associated with a positive or negative perception of the concept or brand. For example, semantic or sentiment analysis can be used to determine positive and negative connotations. In one embodiment, the impact score represents an aggregated of the determined perception information for a given period or instance in time. Although the impact score is described with respect to positive and negative perceptions, it is contemplated that the scoring module 507 can analyze the extracted mentions against any sentiment, mood, or perception that is associated with or indicated by a given folksonomic vocabulary 517.

In one embodiment, the scoring module 507 interacts with the segmentation module 509 perform static segmentation, dynamic segmentation, or a hybrid static/dynamic segmentation. As previously described, the segmentation module 509 enables a user (e.g., a concept marketer 101) to specify segmentation seeds to initiate the process of dynamic segmentation. In one embodiment, the segmentation seeds are static segments that are, for instance, demographics-based. The segmentation module 509 uses the static segments as a starting state. Then as user content is processes and new segments are discovered the segmentation module 509 can dynamically update the starting state to reflect discovered segments.

In one embodiment, the folksonomic object scoring platform 115 includes a prediction module 511 for providing a predicting scoring service. The prediction module 511 uses ensemble predictive models to calculate a predicted impact score for a concept or brand for a future time period. For example, the prediction module 511 combines linear regression and neural network models into a predictive scorecard. In one embodiment, the predictive models leverage a PMML cloud-based engine such as the Adaptive Decision and Predictive Analytics (ADAPA) engine. In one embodiment, the model's data dictionary contains all the definitions for data fields (input variables) used in the model. The dictionary also specifies the data field types and value ranges. In PMML, the content of a “Data Field” element defines the set of values which are considered to be valid or default parameters. Each PMML model also contains one “Mining Schema” which lists fields used in the model.

In one embodiment, the neural network model represent a model trained by the use of a back propagation algorithm. For example, a neural network model is composed of an input layer, one or more hidden layers and an output layer. In one embodiment, the model used by the prediction module 511 is composed of an input layer containing many input nodes, multiple hidden layers with neurons, and an output layer with output neurons. All input nodes are connected to all neurons in the hidden layer via connection weights. By the same extent, all neurons in the hidden layer are connected to the output neuron in the output layer. Each neuron receives one or more input values, each coming via a network connection, and are contained in the corresponding neuron element. Each connection of the element neuron stores the ID of a node it comes from and the weight. A bias weight coefficient or a width or a radial basis function unit may also be stored as an attribute of the neuron element.

In one embodiment, the score tracking module 513 interacts with the scoring module 507 and/or the score tracking module 513 to monitor calculated and/or predicted impact scores against preset thresholds. If the thresholds are reached, the score tracking module 513 may present actionable alerts to a concept marketer 101. In one embodiment, the actionable alert will indicate the thresholds reached and provide for options for responding. For example, a concept marketer 101 may set an alert to trigger when a competing concept or brand achieves 50% of the positive impact score of concept or brand owned by the marketer 101. In this example, if the threshold is reached, the concept marketer 101 may automatically trigger a new promotion or other campaign to address the impact score. In one embodiment, the score tracking module 513 can set thresholds based on actual score values or a rate of change of the score values. For example, if a concept's or brand's impact scores are predicted to fall a fast rate, an alert or action may be triggered.

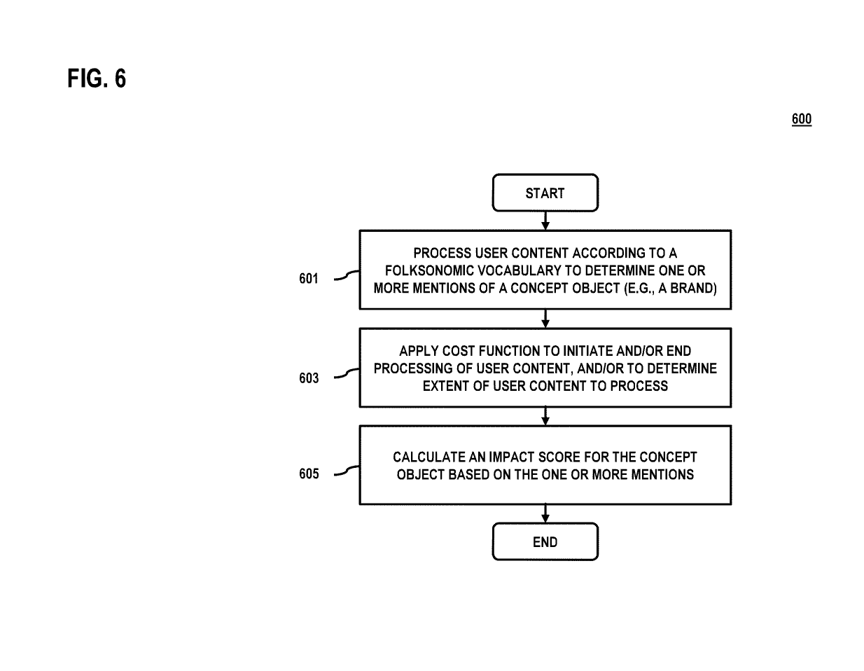

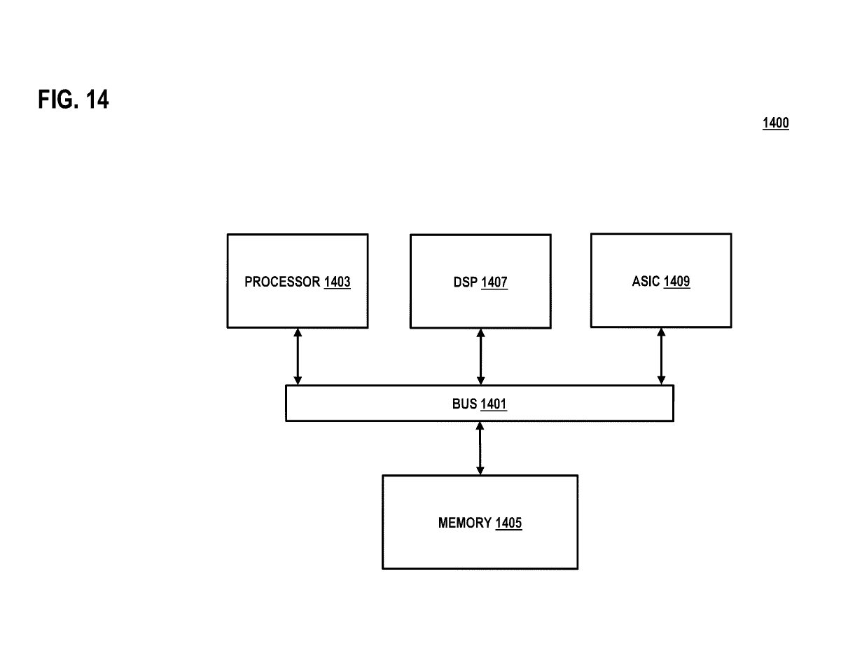

FIG. 6 is a flowchart of a process for calculating an impact score via a folksonomic object scoring platform, according to one embodiment. In one embodiment, the folksonomic object scoring platform 115 performs the process 600 and is implemented in, for instance, a chip set including a processor and a memory as shown in FIG. 14. In addition or alternatively, the scoring application 117 may perform all or a portion of the process 600.

In step 601, the folksonomic object scoring platform 115 processes user content according to a folksonomic vocabulary to determine one or more mentions of a concept object in the user content. In one embodiment, the concept object is a brand, a product associated with the brand, or a combination thereof. In other embodiments, the concept object may represent people, ideas, other items, and/or any other item/entity for which user perception can be measured. For example, from an enterprise customer's perspective, the folksonomic score service of the platform 115 can facilitate engagement in a tiered use of a combination of text, speech, and social analytics in conjunction with customer feedback mechanisms (e.g., all examples of user content as used herein) in order to get a balanced picture of customer behavior and opinion regarding enterprise concepts or brands.

In one embodiment, the folksonomic object scoring platform 115 performs a lexical analysis, a semantic analysis, or a combination thereof on the one or more mentions to determine user sentiment information. The impact score is then further based on the user sentiment information. It is also contemplated any type of analysis such as the analysis 407 of FIG. 4 may employed to further extraction user perception, opinions, and/or sentiment information for calculating an impact score for a concept or brand.

In step 603, the folksonomic object scoring platform 115 applies a cost function to determine an initiation of the processing, an ending of the processing, an extent of the user content, or a combination thereof. As previously described the extent of a user content or digital data wake can be quite extensive and span both free and paid data sources. For example, it is estimated that 80% of US online adults have created over 188 billion influence impressions (e.g., user content or digital data wakes) of products and services. As a result, the amount of resources needed to collate and process this information can be significant.

To avoid such a resource burden, concept marketers 101 can specify particular data sources to process and/or cost functions for specifying cost thresholds at which to start or stop data processing, as well as the amount or extend of data to process. For example, when processed user content data for a digital-consumer reaches a predetermined size limit (e.g., 1 gigabyte of data), the folksonomic scoring platform 115 can end processing or limit the amount of the user content to process. In one embodiment, concept marketers 101 may specify vector definitions include user content or wake data preferences and cost functions.

In step 605, the folksonomic object scoring platform 115 calculates an impact score for the concept object based on the one or more mentions or other indicator of user opinion or perception of the concept object. As previously described, in one embodiment, the scoring is based on application a high-velocity model-based analysis using techniques such as correlation, clustering, pattern analysis, segmentation, semantic analysis, sentiment analysis, social analysis, trend analysis, and/or ontological analysis.

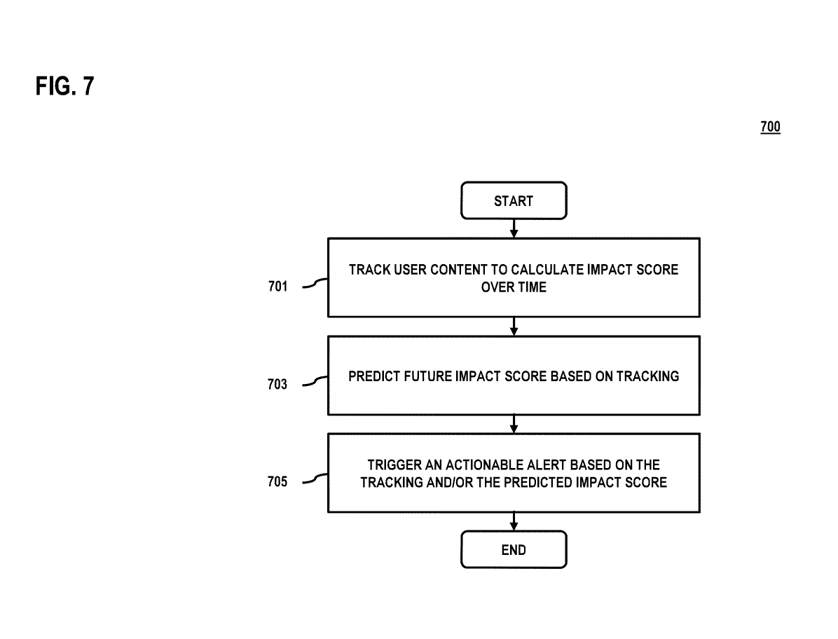

FIG. 7 is a flowchart of a process for predicting impact scores and triggering actionable alerts based on the predicted impact scores, according to one embodiment. In one embodiment, the folksonomic object scoring platform 115 performs the process 700 and is implemented in, for instance, a chip set including a processor and a memory as shown in FIG. 14. In addition or alternatively, the scoring application 117 may perform all or a portion of the process 700. The process 700 provides optional steps that can be performed in conjunction with the process 600 of FIG. 6.

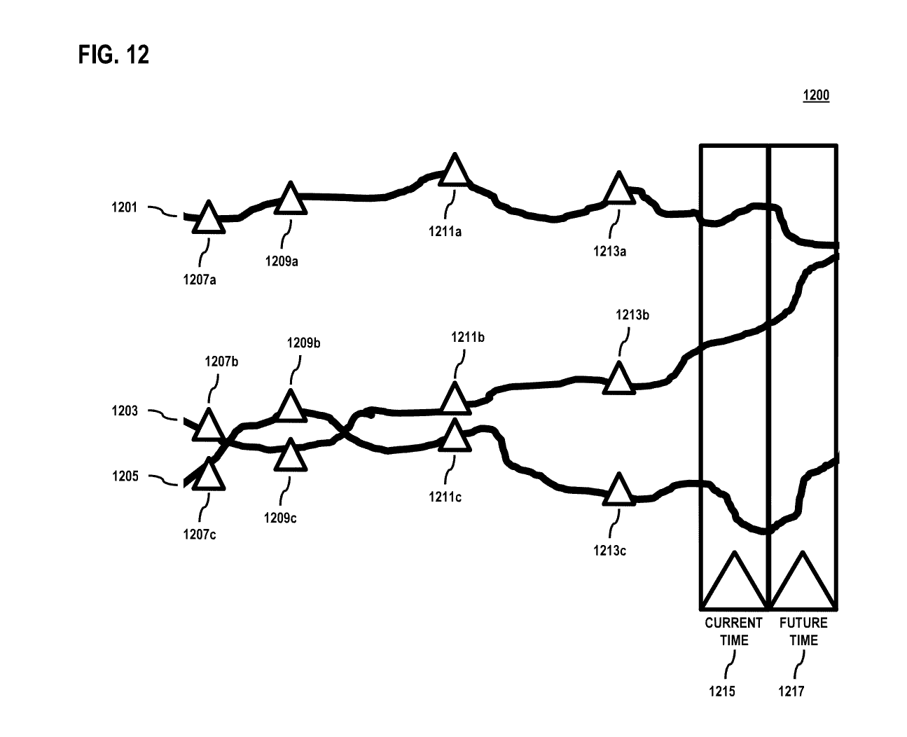

In step 701, the folksonomic object scoring platform 115 performs a tracking of the user content to calculate the impact score over a period of time. For example, the folksonomic object scoring platform 115 can collate user content and/or digital data wakes into discrete time periods for scoring according to the process 600 of FIG. 6. In this way, calculated impact scores can be associated with specific time periods for tracking over time. An example of impact scores tracked over a period of time is discussed with respect to the example of FIG. 12 below. In one embodiment, tracking includes monitoring raw score values as well as the rates of change of those values.

In step 703, the folksonomic object scoring platform 115 predicts the impact score for a future period based on the tracking. In one embodiment, the tracking of step 701 extends into the future based on predicted scoring. As previously noted, predictive scoring can be based on ensemble predictive models that are for instance based on PMML. Ensemble models, for instance, combine different types of predictive models (e.g., linear regression, neural networks, etc.) to generate a predictive scorecard. Because of the use of ensemble models, the predictive scoring of the folksonomic object scoring platform 115 can leverage both inductive and deductive reasoning to improve predicted scores. For example, inductive reasoning enables drawing probabilistic conclusions based on particular instances, while deductive reasoning reaches a determinative conclusion from more general statements.

In step 705, the folksonomic object scoring platform 115 triggers an actionable alert based on the tracking, the predicting, or a combination thereof. In one embodiment, a concept marketer 101 can specify specific thresholds for impact scores and/or the rates of change of the impact scores that can trigger an actionable alert. For example, an alert can be configured to start, pause, or cancel a marketing campaign based on changes in actual and/or predicted impact scores.

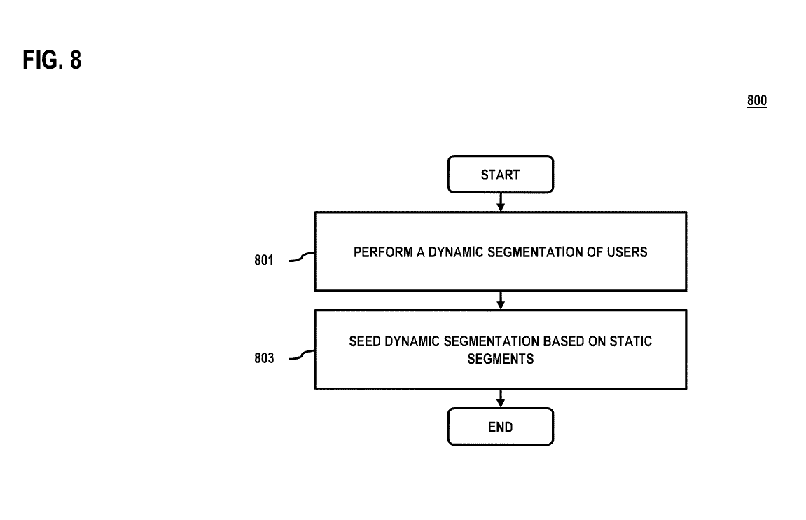

FIG. 8 is a flowchart of a process for segmenting users via a folksonomic object scoring platform, according to one embodiment. In one embodiment, the folksonomic object scoring platform 115 performs the process 800 and is implemented in, for instance, a chip set including a processor and a memory as shown in FIG. 14. In addition or alternatively, the scoring application 117 may perform all or a portion of the process 800. The process 800 provides optional steps that can be performed in conjunction with the process 600 of FIG. 6.

In step 801, the folksonomic object scoring platform 115 performs a dynamic segmentation of one or more users associated with the user content based on the processing, the impact score, or a combination thereof. For example, the processing of the user content may review aspirational goals associated with users based on their posted user content. Users may post, for instance, about their desire or willingness to buy products in a certain price range (e.g., $15-$20). As more users, express the same aspiration, then the folksonomic object scoring platform 115 can begin segmenting users based on this common aspiration. Because the aspirations emerge from the analysis of user content, they are discovered and segmented organically by the folksonomic object scoring platform 115.

In step 803, the folksonomic object scoring platform 115 seeds the dynamic segmentation based on one or more static segments of the one or more users. In one embodiment, the folksonomic object scoring platform 115 facilitates a cross-tuning of the dynamic segments determined in step 801 by allowing the seeding (or initial identification) of static segments as an initial basis for dynamic segmentation. For example, digital-consumers or users in the same general demographics may tend to hold the same aspirations and dynamic segments within the same static segment may be more easily identifiable. However, it is contemplated that static segments represent just a starting point. Accordingly, as dynamic segments are discovered and updated, it is contemplated that users grouped within a dynamic segment are likely to cross static segments.

As previously discussed, in one embodiment, the process 800 is initiated by selecting static segments from a master list of segments as initial seeds. The seed static segments are then included in a vector definition that includes other configuration information for folksonomic object scoring (e.g., data sources, cost functions, etc.).

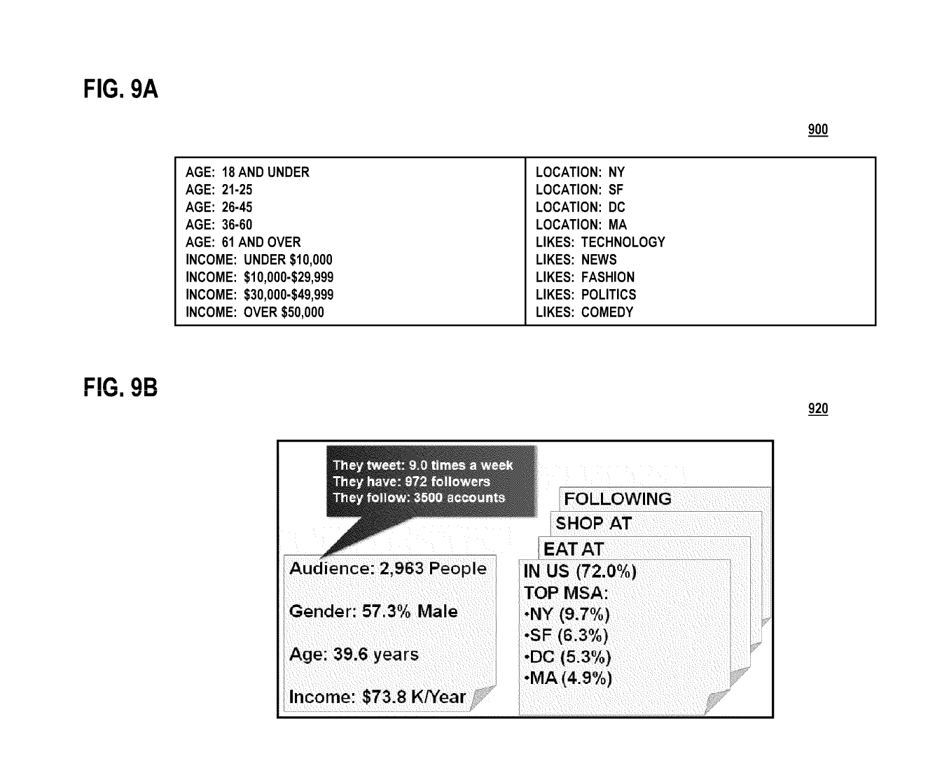

FIGS. 9A and 9B are diagrams of respectively static segments and dynamic segments, according to various embodiments. FIG. 9A illustrates examples of traditional static segments that can be used as seeds as listed in table 900. In this example, the static segments are based on traditional demographic properties such as age, income, and location. In addition, static segments may also cover user preferences such as “likes” or preferred topics of interest. As previously described, static segments are discrete predefined consumer segments that are traditionally set by marketers, surveyors, and the like. Typically, the segments (as suggested by their names) and the criteria for classifying users into the segments remain unchanging.

FIG. 9B illustrates an example 920 of static segmentation. In this example, the dynamic segments are mapped onto the seeded static segments (e.g., gender, age, income, etc.), but also show aspirational goals of the segment such as the likely places where they eat and shop, as well as who they are following. Such places are likely to change over or evolve over time and the dynamic segmentation provided by the folksonomic object scoring platform 115 can also dynamically update the segment as those preferences change over time. For example, this segment of 57% males who are 39.6 years old and have an income of $73.8K/year may prefer to eat at Restaurant A with a certain price range for a period of time. Depending on the user content (e.g., social media impressions) generated by this group, the folksonomic object scoring platform 115 may reclassify or predict a reclassification of the segment to prefer Restaurant B with another price range for another period of time.

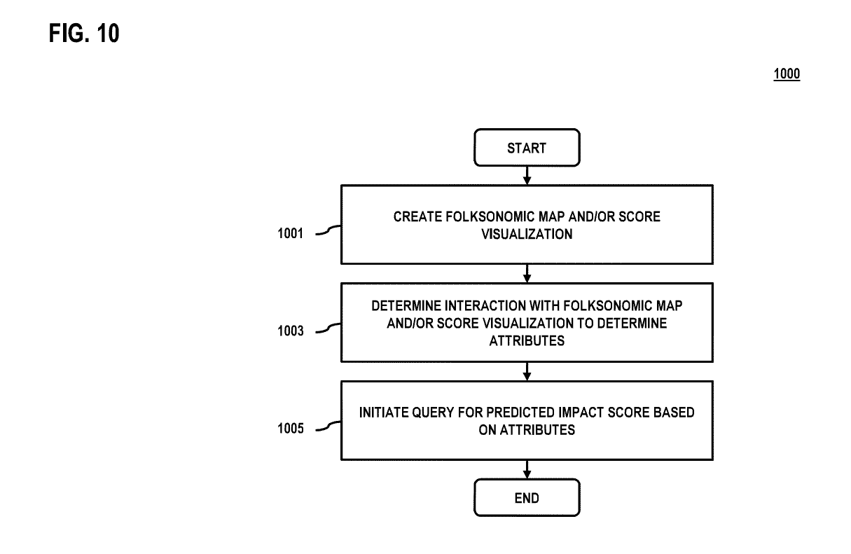

FIG. 10 is a flowchart of a process for creating a folksonomic map and/or score visualization, according to one embodiment. In one embodiment, the folksonomic object scoring platform 115 performs the process 1000 and is implemented in, for instance, a chip set including a processor and a memory as shown in FIG. 14. In addition or alternatively, the scoring application 117 may perform all or a portion of the process 1000. The process 1000 provides optional steps that can be performed in conjunction with the process 600 of FIG. 6.

In step 1001, the folksonomic object scoring platform 115 creates a folksonomic map, a score visualization, or a combination thereof of the one or more users, the impact score, or a combination thereof. In one embodiment, the folksonomic map or score visualization assist content marketers 101 to visually understand the discovered dynamic segments as well as impact scores in relation to static segments.

In step 1003, the folksonomic object scoring platform 115 determines an interaction with the folksonomic map, the score visualization, or a combination thereof to specify one or more attributes of the one or more users, the concept object, the impact score, or a combination thereof. For example, the folksonomic object scoring platform 115 enables creation of interactive queries for exploring processed user content or digital data wakes. More specifically, concept marketers 101 can interactively change folksonomic map or visualization attributes. For example marketers can select specific representations of dynamic or static consumer segments in the maps or visualization to view of select attributes associated with the selected segments. These attributes can include dynamically discovered user attributes (e.g., propensity to buy a product, preferred locations to eat, etc.) as well as attributes associated with static segments such as demographic information.

In step 1005, the folksonomic object scoring platform 115 initiates a query for a predicted impact score based on the one or more attributes. In one embodiment, when responding to the query, the folksonomic object scoring platform 115 consults the appropriate models (e.g., based on the attributes selected) and provides a supervised reference range based results. In one embodiment, the results may be displayed in a dashboard interface or portal to the folksonomic object scoring platform 115.

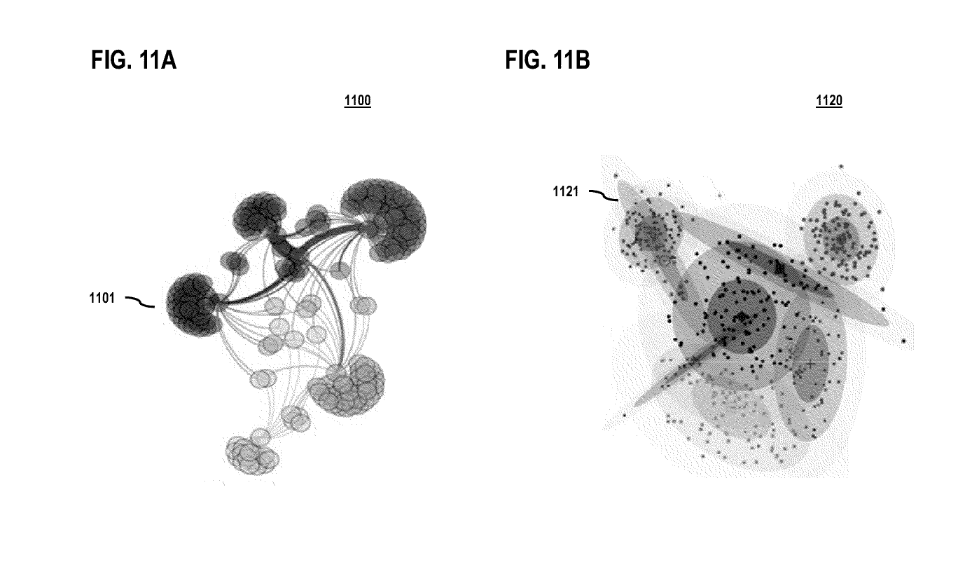

FIGS. 11A and 11B are diagrams of respectively of a folksonomic map based on dynamic segments and a folksonomic map based on static segments, according to various embodiments. In these example, both graph 1100 of FIG. 11A and graph 1120 of FIG. 11B provide a folksonomic map and score visualization for identified digital-consumer communities. Graph 1100 of FIG. 11A represents a folksonomic map and score visualization that is a continuously changing aggregation of dynamic attributes associated with dynamic segments of consumers. For example, the darker bubbles 1101 represent an aggregation of thousands of digital-consumer conversations aligned with a dynamically discovered folksonomic category (e.g., insurance, automotive, US, propensity to engage). In one embodiment, the edge and/or clustering thickness may represent relationships between the dynamic segments as well as how well the members of the segment correlate to the corresponding dynamic segments.

Graph 1120 of represents an impact score visualization based on a set of static segments. In this case, each static segment 1121 depicted in the graph 1120 is classified into a macro band of clustered communities that are segmented according to static criteria (e.g., income of less than $64K/year, 23<Age<55, brand X/Y/Z associated shading, recency-frequency-monetization score).

FIG. 12 is a diagram of an impact score graph, according to one embodiment. Graph 1200 illustrates an impact score graph for three different brands (e.g., brand 1201, brand 1203, and brand 1205). Graph 1200 differs substantially from traditional word cloud representations that may depict mentions or text associated with each brand as a collection of words with the size of each word representing its presence or association with a particular brand. For example, if brand 1201 were associated with a slogan (e.g., Slogan A), the slogan would be depicted in the graph with larger letters.

Graph 1200 represents brand perception information as a graph based on calculated and predicted impact scores. As shown, each brand 1201-1203 is represented with a line graph with time as the X-axis and impact score as the Y-axis. In this case brand 1201 has the highest initial impact score, followed by brand 1203 and brand 1205. Each triangle marker 1207a-c, 1209a-c, 1211a-c, and 1213a-c represents events that have potential effects on brand impact scores. For example, markers 1207a-c may represent a point in time where brand 1205 initiated a new marketing campaign. As shown in graph 1200, the brand impact score for brand 1205 receives a boost and overtakes the impact score for brand 1203, but appears to have little to no effect on brand 1201. For a brand marketer, the graph 1200 gives clear indication of the effectiveness the marketing campaign at marker 1207a-c. As each subsequent event occurs (e.g., not necessarily marketing events, but may also include things such as bad earnings news, law suits, etc.), the brand marketers can monitor or track the potential impact scores.

In one embodiment, the graph provides historical impact scores (e.g., scores occurring before the current time 1215), as well as scores for the current time 1215 and predicted scores for a future time 1217. For example, predicted increases or decreases in the impact scores can alert and trigger a brand manager to take action (e.g., launch a new campaign, issue press releases, etc.) to address potential changes. In other cases, if predictions show that impact scores may increase despite a current decrease (e.g., as in the case of brand 1203 in the current time 1215 and the future time 1217), then a brand marketer need not expend resources to address the problem at that time.

More specifically, score visualizations such as graph 1200 provide almost real-time information on whether consumers will have a propensity to act in response to a concept or brand. This is, for instance, based on tracking contextual opinions and perceptions over discrete time units using the various embodiments of the folksonomic scoring mechanism discussed with respect to the various embodiments described herein. For example, because the opinions and perceptions as expressed through calculated impact scores are based on a wide range of user content or digital media (e.g., news, blogs, newsgroups, images, video blogs, audio blogs, social media, etc.), the impact scores provided by the folksonomic object scoring platform 115 can be a powerful tool.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The processes described herein for providing folksonomic object scoring can be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

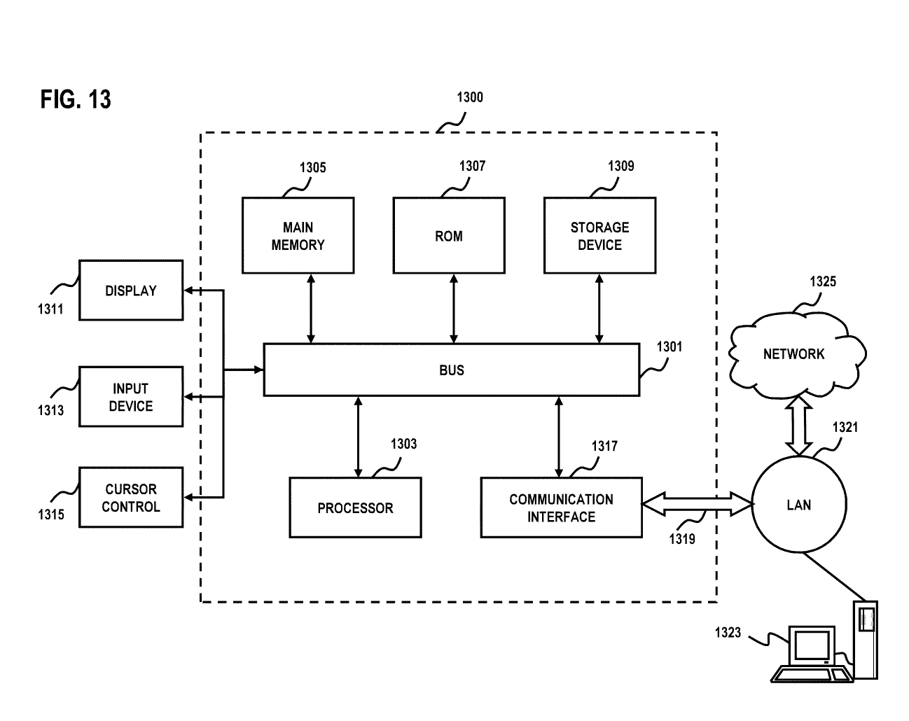

FIG. 13 illustrates computing hardware (e.g., computer system) upon which an embodiment according to the invention can be implemented. The computer system 1300 includes a bus 1301 or other communication mechanism for communicating information and a processor 1303 coupled to the bus 1301 for processing information. The computer system 1300 also includes main memory 1305, such as random access memory (RAM) or other dynamic storage device, coupled to the bus 1301 for storing information and instructions to be executed by the processor 1303. Main memory 1305 also can be used for storing temporary variables or other intermediate information during execution of instructions by the processor 1303. The computer system 1300 may further include a read only memory (ROM) 1307 or other static storage device coupled to the bus 1301 for storing static information and instructions for the processor 1303. A storage device 1309, such as a magnetic disk or optical disk, is coupled to the bus 1301 for persistently storing information and instructions.

The computer system 1300 may be coupled via the bus 1301 to a display 1311, such as a cathode ray tube (CRT), liquid crystal display, active matrix display, or plasma display, for displaying information to a computer user. An input device 1313, such as a keyboard including alphanumeric and other keys, is coupled to the bus 1301 for communicating information and command selections to the processor 1303. Another type of user input device is a cursor control 1315, such as a mouse, a trackball, or cursor direction keys, for communicating direction information and command selections to the processor 1303 and for controlling cursor movement on the display 1311.

According to an embodiment of the invention, the processes described herein are performed by the computer system 1300, in response to the processor 1303 executing an arrangement of instructions contained in main memory 1305. Such instructions can be read into main memory 1305 from another computer-readable medium, such as the storage device 1309. Execution of the arrangement of instructions contained in main memory 1305 causes the processor 1303 to perform the process steps described herein. One or more processors in a multi-processing arrangement may also be employed to execute the instructions contained in main memory 1305. In alternative embodiments, hard-wired circuitry may be used in place of or in combination with software instructions to implement the embodiment of the invention. Thus, embodiments of the invention are not limited to any specific combination of hardware circuitry and software.

The computer system 1300 also includes a communication interface 1317 coupled to bus 1301. The communication interface 1317 provides a two-way data communication coupling to a network link 1319 connected to a local network 1321. For example, the communication interface 1317 may be a digital subscriber line (DSL) card or modem, an integrated services digital network (ISDN) card, a cable modem, a telephone modem, or any other communication interface to provide a data communication connection to a corresponding type of communication line. As another example, communication interface 1317 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1317 sends and receives electrical, electromagnetic, or optical signals that carry digital data streams representing various types of information. Further, the communication interface 1317 can include peripheral interface devices, such as a Universal Serial Bus (USB) interface, a PCMCIA (Personal Computer Memory Card International Association) interface, etc. Although a single communication interface 1317 is depicted in FIG. 13, multiple communication interfaces can also be employed.

The network link 1319 typically provides data communication through one or more networks to other data devices. For example, the network link 1319 may provide a connection through local network 1321 to a host computer 1323, which has connectivity to a network 1325 (e.g. a wide area network (WAN) or the global packet data communication network now commonly referred to as the “Internet”) or to data equipment operated by a service provider. The local network 1321 and the network 1325 both use electrical, electromagnetic, or optical signals to convey information and instructions. The signals through the various networks and the signals on the network link 1319 and through the communication interface 1317, which communicate digital data with the computer system 1300, are exemplary forms of carrier waves bearing the information and instructions.

The computer system 1300 can send messages and receive data, including program code, through the network(s), the network link 1319, and the communication interface 1317. In the Internet example, a server (not shown) might transmit requested code belonging to an application program for implementing an embodiment of the invention through the network 1325, the local network 1321 and the communication interface 1317. The processor 1303 may execute the transmitted code while being received and/or store the code in the storage device 1309, or other non-volatile storage for later execution. In this manner, the computer system 1300 may obtain application code in the form of a carrier wave.

The term “computer-readable medium” as used herein refers to any medium that participates in providing instructions to the processor 1303 for execution. Such a medium may take many forms, including but not limited to non-volatile media, volatile media, and transmission media. Non-volatile media include, for example, optical or magnetic disks, such as the storage device 1309. Volatile media include dynamic memory, such as main memory 1305. Transmission media include coaxial cables, copper wire and fiber optics, including the wires that comprise the bus 1301. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 14 illustrates a chip set 1400 upon which an embodiment of the invention may be implemented. Chip set 1400 is programmed to securely transmit payments and healthcare industry compliant data from mobile devices lacking a physical TSM and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of FIGS. 6-8 and 10.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1405 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
processing user content according to a folksonomic vocabulary to determine one or more mentions of a concept object in the user content, wherein an initiation of the processing, an ending of the processing, an extent of the user content, or a combination thereof is based on a cost function; and
calculating an impact score for the concept object based on the one or more mentions.

2. A method of claim 1, wherein the concept object is a brand, a product associated with the brand, or a combination thereof.

3. A method of claim 1, further comprising:
performing a lexical analysis, a semantic analysis, or a combination thereof on the one or more mentions to determine user sentiment information,
wherein the impact score is further based on the user sentiment information.

4. A method of claim 1, further comprising:
performing a tracking of the user content to calculate the impact score over a period of time.

5. A method of claim 4, further comprising:
predicting the impact score for a future period based on the tracking.

6. A method of claim 5, further comprising:
triggering an actionable alert based on the tracking, the predicting, or a combination thereof.

7. A method of claim 1, further comprising:
performing a dynamic segmentation of one or more users associated with the user content based on the processing, the impact score, or a combination thereof.

8. A method of claim 7, further comprising:
seeding the dynamic segmentation based on one or more static segments of the one or more users.

9. A method of claim 1, further comprising:
creating a folksonomic map, a score visualization, or a combination thereof of the one or more users, the impact score, or a combination thereof.

10. A method of claim 9, further comprising:
determining an interaction with the folksonomic map, the score visualization, or a combination thereof to specify one or more attributes of the one or more users, the concept object, the impact score, or a combination thereof; and
initiating a query for a predicted impact score based on the one or more attributes.

11. An apparatus comprising a processor configured to:
processing user content according to a folksonomic vocabulary to determine one or more mentions of a concept object in the user content, wherein an initiation of the processing, an ending of the processing, an extent of the user content, or a combination thereof is based on a cost function; and
calculating an impact score for the concept object based on the one or more mentions.

12. An apparatus of claim 11, wherein the concept object is a brand, a product associated with the brand, or a combination thereof.

13. An apparatus of claim 11, wherein the apparatus is further configured to:
perform a tracking of the user content to calculate the impact score over a period of time.

14. An apparatus of claim 13, wherein the apparatus is further configured to:
predict the impact score for a future period based on the tracking.

15. An apparatus of claim 14, wherein the apparatus is further configured to:
trigger an actionable alert based on the tracking, the predicting, or a combination thereof.

16. An apparatus of claim 11, wherein the apparatus is further configured to:
perform a dynamic segmentation of one or more users associated with the user content based on the processing, the impact score, or a combination thereof.

17. An apparatus of claim 11, wherein the apparatus is further configured to:
create a folksonomic map, a score visualization, or a combination thereof of the one or more users, the impact score, or a combination thereof;
determine an interaction with the folksonomic map, the score visualization, or a combination thereof to specify one or more attributes of the one or more users, the concept object, the impact score, or a combination thereof; and
initiate a query for a predicted impact score based on the one or more attributes.

18. A system comprising:
an object scoring platform configured to process user content according to a folksonomic vocabulary to determine one or more mentions of a concept object in the user content, wherein an initiation of the processing, an ending of the processing, an extent of the user content, or a combination thereof is based on a cost function; and to calculate an impact score for the concept object based on the one or more mentions

19. A system of claim 18, wherein the object scoring platform is further configured to perform a lexical analysis, a semantic analysis, or a combination thereof on the one or more mentions to determine user sentiment information; and wherein the impact score is further based on the user sentiment information.

20. A system of claim 18, wherein the object scoring platform is further configured to perform a tracking of the user content to calculate the impact score over a period of time, and to predict the impact score for a future period based on the tracking.
